(19) United States
(12) Patent Application Publication
(10) Pub. No.: US 2024/0031168 A1
(43) Pub. Date: Jan. 25, 2024

(54) Apparatus, Device, Method, and Computer Program for Determining an Integrity of a Generated Cryptographic Signature

(71) Applicants: Yingchen WANG, Austin, TX (US); Santosh GHOSH, Hillsboro, OR (US); Manoj SASTRY, Portland, OR (US); Qian WANG, Portland, OR (US); Lucian COJOCAR, Seattle, WA (US)

(72) Inventors: Yingchen WANG, Austin, TX (US); Santosh GHOSH, Hillsboro, OR (US); Manoj SASTRY, Portland, OR (US); Qian WANG, Portland, OR (US); Lucian COJOCAR, Seattle, WA (US)

(21) Appl. No.: 18/476,534

(22) Filed: Sep. 28, 2023

(51) Int. Cl. H04L 9/32

(52) U.S. Cl. CPC H04L 9/3247; H04L 9/3236

(57) ABSTRACT

Various examples relate to an apparatus, device, method, and computer program for determining an integrity of a generated cryptographic signature. The apparatus is to generate, before generating the cryptographic signature, redundancy information of at least one cryptographic secret being used for generating the cryptographic signature, generate the cryptographic signature using the at least one cryptographic secret, compare, after generating the cryptographic signature, the redundancy information and the at least one cryptographic secret to determine whether the redundancy information matches the at least one cryptographic secret, and use the cryptographic signature if the redundancy information matches the at least one cryptographic secret.

### BACKGROUND

Crystals-Dilithium is an encryption algorithm that was selected as primary candidate for future Digital Signatures in a competition on Post-Quantum Cryptography algorithms held by the National Institute for Standards and Technology (NIST). Standardization of Crystals-Dilithium is assumed to be finalized in 2024. Crystals-Dilithium is expected to replace non-quantum-safe ECDSA (Elliptic Curve Digital Signature Algorithm)/RSA (Rivest-Shamir-Adleman)-based digital signature schemes as new standard. Dilithium has randomized and deterministic modes of signing. In a randomized mode, it generates a random token, in contrast to using a message-dependent token in deterministic mode.

If Dilithium is used as signature scheme for post-quantum cryptography, the algorithm would be widely deployed. Its resilience against fault attacks is crucial because it can leak sensitive private keys. The so-called Rowhammer attack is a well-known technique to induce faults on general-purpose CPUs (Central Processing Units) without any physical access, see Kim et al: Flipping bits in memory without accessing them: An experimental study of DRAM disturbance errors (ACM International Symposium on Computer Architecture. 2014). Islam et al: Signature Correction Attack on Dilithium Signature Scheme (IEEE European Symposium on Security and Privacy. 2022) demonstrated Rowhammer attacks being used to disclose the Dilithium private key. Additionally, Bruinderink et al: Differential fault attacks on deterministic lattice signatures (IACR Transactions on Cryptographic Hardware and Embedded Systems. 2018) shows that any generic fault attacks on Dilithium can potentially be exploited as Rowhammer-type attacks. The latter two papers propose a defense that explores temporal redundancy: Re-executing the signature generation and comparing two signatures generated at different time. Such re-execution of the signature (temporal redundancy) requires more than 100% performance overhead. Moreover, both papers propose another defense (Verify-after-Sign) that verifies a signature after its generation. Verify-after-Sign can provide fault tolerance against Rowhammer attacks but still introduces a 30% performance overhead.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for determining an integrity of a generated cryptographic signature, and of a computer system or mobile device comprising such an apparatus or device;

FIG. 1b shows a flow chart of an example of a method for determining an integrity of a generated cryptographic signature;

FIG. 2 shows a diagram of a performance overhead; and

FIG. 3 shows a diagram of a memory overhead.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

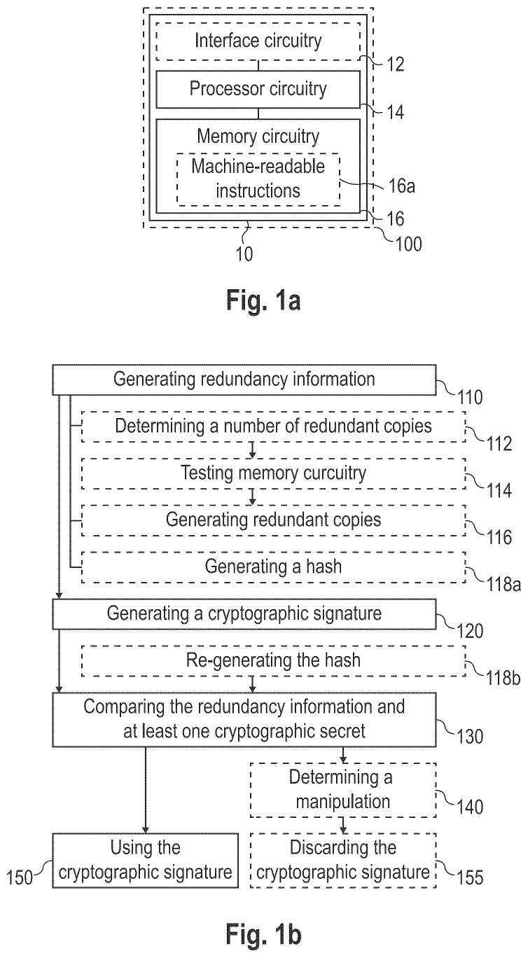

FIG. 1a shows a schematic diagram of an example of an apparatus 10 or device 10 for determining an integrity of a generated cryptographic signature, and of a computer system 100 or mobile device 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises optional interface circuitry 12, processor circuitry 14, and memory circuitry 16. For example, the processor circuitry 14 may be coupled with the interface circuitry 12, and with the memory circuitry 16. For example, the processor circuitry 14 may provide the functionality of the apparatus, in conjunction with the interface circuitry 12 (for exchanging information, e.g., with other components inside or outside the computer system 100 or mobile device 100 comprising the apparatus 10 or device 10), the memory circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory circuitry 16, a storage circuitry (not shown), or means for storing information 16.

The processor circuitry 14 or means for processing 14 is to generate, before generating the cryptographic signature, redundancy information of at least one cryptographic secret being used for generating the cryptographic signature. The processor circuitry 14 or means for processing 14 is to generate the cryptographic signature using the at least one cryptographic secret. The processor circuitry 14 or means for processing 14 is to compare, after generating the cryptographic signature, the redundancy information and the at least one cryptographic secret to determine whether the redundancy information matches the at least one cryptographic secret. The processor circuitry 14 or means for processing 14 is to use the cryptographic signature if the redundancy information matches the at least one cryptographic secret.

FIG. 1b shows a flow chart of an example of a corresponding method for determining the integrity of a generated cryptographic signature. The method comprises generating 110, before generating the cryptographic signature, the redundancy information of the at least one cryptographic secret being used for generating the cryptographic signature. The method comprises generating 120 the cryptographic signature using the at least one cryptographic secret. The method comprises comparing 130, after generating the cryptographic signature, the redundancy information and the at least one cryptographic secret to determine whether the redundancy information matches the at least one cryptographic secret. The method comprises using 150 the cryptographic signature if the redundancy information matches the at least one cryptographic secret. For example, the method may be performed by the computer system 100 or the mobile device 100, e.g., by the apparatus 10 or device 10 of the computer system 100 or mobile device 100.

In the following, the features of the apparatus 10, device 10, computer system/mobile device 100, method and of a corresponding computer program will be introduced in more detail with reference to the apparatus 10. Features introduced in connection with the apparatus 10 may likewise be included in the corresponding device 10, computer system/mobile device 100, method and corresponding computer program.

Various examples of the present disclosure relate to digital cryptographic signature, and in particular to protecting against manipulation of such digital cryptographic signatures during signature generation, which may be used for snooping cryptographic secrets bit-by-bit, with the goal of eventually reconstructing the cryptographic secret. Such attacks may, for example, work by flipping a random bit of the secret key (using a Rowhammer-style attack), with the goal of generating a faulty signature. While the faulty signature does not verify, it is possible to modify the faulty signature with a signature correction algorithm to determine the flipped bit, as the 1-bit bit flip results in a corrupted cryptographic secret that is modified by a deterministic number of bits (i.e., 1 bit), resulting in 2·number of bits of the cryptographic secret different deltas between the correct cryptographic secret and the faulty cryptographic secret. By cancelling the respective delta values in the faulty cryptographic secret, the attacker learns which delta leads to a signature that can be verified, and thus the original value of the flipped bit. To obtain the entire cryptographic secret, such as the private key, this procedure needs to be repeated for a sufficient number of bits of the cryptographic secret. This attack is based on the attacker getting hold of the faulty signatures. At this point, the proposed concept introduces an additional, spatial redundancy check that avoids disclosing faulty cryptographic signatures, such that the attacker cannot use them to reconstruct the cryptographic secret.

The proposed concept is based on two techniques—spatial redundancy, and verification of the cryptographic secret being used with the help of the spatial redundancy. This spatial redundancy is based on making a copy of the relevant cryptographic secret(s) being used to generate the cryptographic signature before the cryptographic signature is being generated and comparing the cryptographic signature having been used for generating the cryptographic signature to the copy. In this context, this copy is not necessarily a bit-by-bit copy of the cryptographic secret—in some examples, as will be shown in the following, a hash of the cryptographic secret may suffice. In any case, the redundancy information is stored spatially separate from the cryptographic secret, such that a bit flip that is triggered in the cryptographic secret is not triggered in the redundancy information as well.

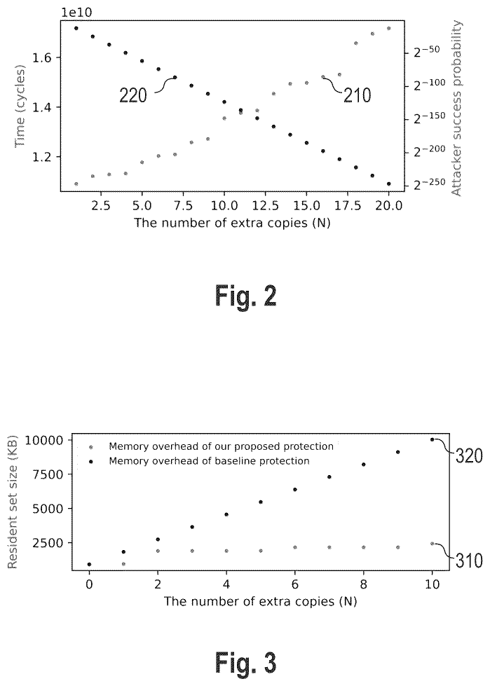

The processor circuitry is to generate, before generating the cryptographic signature, the redundancy information of at least one cryptographic secret being used for generating the cryptographic signature. In this context, a cryptographic secret is a secret bit value that is being used as parameter for generating the cryptographic signature. A cryptographic secret is therefore generally not encrypted itself but used for performing encryption and/or signing. For example, the redundancy information may be generated when the respective cryptographic secret is initialized, or when a computer system or mobile device generating the cryptographic signature is started up. In some cases, a portion of the at last one cryptographic secret (e.g., at least one long-term cryptographic parameter, such as the private key being used to generate the cryptographic secret) may be stored as part of the redundancy information at initialization (of the respective cryptographic parameter, or of the computer system/mobile device), while another portion (e.g., at least one short-term cryptographic parameter (e.g., μ of the Crystals-Dilithium signing algorithm) may be stored as part of the redundancy information once it is generated during the algorithm. Alternatively, short-term cryptographic parameters, which might be used only once, might not be stored redundantly at all. In more general terms, the at least one cryptographic secret may comprise at least one short-term cryptographic parameter (e.g., a cryptographic secret that is valid only for a single signing operation) and at least one long-term cryptographic parameter (e.g., a cryptographic secret that is valid across multiple signing operations, such as the secret/private key). For example, the at least one cryptographic secret may comprise at least one of the cryptographic parameters s₁ (secret vector 1), A (public matrix, being derived from ρ), μ (the message), ρ (the seed, which may be random or pseudo-randomly derived from the information being signed) of the Crystal-Dilithium cryptographic signing algorithm. Of these parameters, s₁ may be a long-term cryptographic parameter (and optionally A and ρ if ρ is not pseudo-randomly derived from the information being signed), and μ (and A and ρ if ρ is pseudo-randomly derived from the information being signed) may be short-term cryptographic parameters. As discussed in connection with FIGS. 2 and 3, the short-term cryptographic parameters may be stored in short-term buffers, and the long-term cryptographic parameters may be stored in long-term buffers. More information on the Crystals-Dilithium algorithm can be found in Shi Bai et al: CRYSTALS-Dilithium. Algorithm Specifications and Supporting Documentation (Version 3.1) (Feb. 8, 2021), which is used as the basis for the nomenclature of variables used in the present document. The processor circuitry may forego generating redundancy information for the at least one short-term cryptographic parameter (as it is only valid once in any keys).

In some examples, the redundancy information may comprise one or multiple copies of at least a portion of the at least one cryptographic secret, e.g., of the long-term cryptographic parameter s₁, and optionally of one or more short-term cryptographic parameters. In other words, the redundancy information may comprise at least one redundant copy of at least a portion of the at least one cryptographic secret. Preferably, to further decrease the likelihood of a successful attack, multiple redundant copies may be used. For example, the redundancy information may comprise at least three (or at least four, or at least five) redundant copies of at least the portion of the at least one cryptographic secret. As shown in FIG. 2, the number of redundant copies directly influences the attacker success probability, with an attacker success probability of 2⁻⁶⁴ being reached with 5 redundant copies of at least the portion of the cryptographic secret. However, the number of redundant copies may be made dependent on the memory circuitry (e.g., dynamic random-access memory, DRAM, circuitry) being used. For example, the processor circuitry may determine a number of redundant copies by testing the memory circuitry being used to store the at least one cryptographic secret. Accordingly, as further shown in FIG. 1b, the method may comprise determining 112 a number of redundant copies by testing 114 the memory circuitry being used to store the at least one cryptographic secret. In particular, the processor circuitry may test the memory circuitry by repeatedly accessing memory cells being located in proximity to a target cell to determine an effort required for flipping at least one bit stored in the target cell, i.e., in line with the Rowhammer attack vector. Depending on the amount of effort required for flipping a bit stored in the target cell, and based on a desired maximal attacker success probability, an appropriate number of redundant copies may be selected (e.g., in line with the discussion in connection with FIG. 2). Additionally, or alternatively, if the effort for flipping a bit varies across the memory circuitry, the processor circuitry may store the at least one cryptographic secret and/or the one or more redundant copies in a portion of the memory circuitry requiring more effort for flipping a bit.

As outlined above, some portions of the at least one cryptographic secret are used across different signing procedures (i.e., the long-term cryptographic parameter(s)), while other portions might be used only once or a few times, such that their corruption is less problematic. This distinction may be considered when making redundant copies. For example, the processor circuitry may generate a larger number of redundant copies for the at least one long-term cryptographic parameter than for the at least one short-term cryptographic parameter. Accordingly, the method may comprise generating 116 a larger number of redundant copies (e.g., at least one more, at least two more, or at least three more) for the at least one long-term cryptographic parameter than for the at least one short-term cryptographic parameter. In some examples, as outlined above, the number of redundant copies for the at least one short-term cryptographic parameter may be zero. In other words, the processor circuitry may forego generating a redundant copy for the at least one short-term cryptographic parameter.

As an alternative (or addition) to redundant copies, the at least one cryptographic secret may be hashed, and the hash may be stored in the redundancy information. For example, the redundancy information may comprise a hash of the at least one cryptographic secret. This may increase the computational overhead while reducing the memory overhead. For example, with a fraction of the memory required for making redundant copies, a similar level of protection may be obtained, as manipulating a hash value to match a manipulated cryptographic secret requires a large number of bit flips (if the hash value is built on a hashing algorithm being based on an avalanche effect). For example, the processor circuitry may generate the hash using a cryptographic hashing function, e.g., using a variant of the secure hashing algorithm (SHA, e.g., SHA, SHA-2, or SHA-3). Accordingly, the method may comprise generating 118a the hash using a cryptographic hashing function. If a hash value is used as comparison target, for the purpose of comparing the at least one cryptographic secret to the redundancy information, the hash may be re-generated after generating the cryptographic signature, and the two hashes may be compared. In other words, the processor circuitry may re-generate the hash based on the at least one cryptographic secret after generating the cryptographic signature and compare the hash and the re-generated hash. Accordingly, as further shown in FIG. 1b, the method may comprise re-generating 118b the hash based on the at least one cryptographic secret after generating the cryptographic signature and comparing the hash and the re-generated hash.

The processor circuitry 14 is to generate the cryptographic signature using the at least one cryptographic secret, e.g., using a suitable signing algorithm. For example, the cryptographic signature may be generated according to a quantum-safe cryptographic signing algorithm, such as according to the Crystal-Dilithium cryptographic signing algorithm. Such algorithms promise to be less or not susceptible to brute-force attacks carried out by quantum computers, so that they are considered safer than the cryptographic algorithms being used conventionally.

After the cryptographic signature is generated (or while the cryptographic signature is being generated, but after the at least one cryptographic secret has been read out from the memory circuitry during generation of the cryptographic signature), the redundancy information and the at least one cryptographic secret are compared to determine whether the redundancy information matches the at least one cryptographic secret. For example, the (portion of the) at least one cryptographic secret may be compared to (all of) the redundant copies of the (portion of the) at least one cryptographic secret. Alternatively, or additionally, after re-generating the hash (value) after the at least one cryptographic secret has been read out from the memory circuitry during generation of the cryptographic signature, the re-generated hash may be compared to the hash stored in the redundancy information. This comparison is done to detect discrepancies between the stored redundancy information and the at least one cryptographic signature that has been/is being used for generating the cryptographic signature. In effect, the processor circuitry may determine a manipulation of the at least one cryptographic secret or of the redundancy information if the redundancy information fails to match the at least one cryptographic secret If this is the case, the processor circuitry may discard the cryptographic signature if a manipulation. Accordingly, as further shown in FIG. 1b, the method may comprise determining 140 the manipulation of the at least one cryptographic secret or of the redundancy information if the redundancy information fails to match the at least one cryptographic secret and discarding 155 the cryptographic signature if a manipulation may be determined. In particular, a bit flip, such as a bit flip caused by a Rowhammer-style attack, may be detected. In more general terms, the manipulation being determined may be based on electrical interaction between adjacent memory cells of the memory circuitry due to repeated access (i.e., “row hammering”) of the memory cells. If the cryptographic signature is discarded, it cannot be used by the attacker to recreate the at least one cryptographic secret.

If no manipulation is detected, i.e., if the redundancy information matches the at least one cryptographic secret, the generated cryptographic secret is used, e.g., to sign a message, document, or other packet of information.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory circuitry 16 or means for storing information 16 may a volatile memory, e.g., random access memory, such as dynamic random-access memory (DRAM) or static random-access memory (SRAM).

For example, the computer system 100 may be at least one of a client computer system, a server computer system, a rack server, a desktop computer system, a mobile computer system, a security gateway, and a router. The mobile device 100 may be one of a smartphone, tablet computer, wearable device, and a mobile computer.

More details and aspects of the apparatus 10, device 10, mobile device/computer system 100, method and computer program are mentioned in connection with the proposed concept, or one or more examples described above or below (e.g., FIG. 2 to 3). The apparatus 10, device 10, mobile device/computer system 100, method and computer program may comprise one or more additional optional features corresponding to one or more aspects of the proposed concept, or one or more examples described above or below.

Various examples of the present disclosure relate to a concept and methods to protect Crystals-Dilithium against Rowhammer attacks.

In contrast to the temporal redundancy-based approaches for addressing Rowhammer attacks, the present disclosure presents a technique that entails spatial redundancy and integrity verification to achieve a solution with a reduced or minimal memory overhead.

In general, a baseline spatial redundancy methodology may copy the entire address space such that the memory overhead grows linearly. To reduce the spatial redundancy, a subset of sensitive key material was identified in the Dilithium Signing procedure that is vulnerable to Rowhammer fault attacks. This subset of sensitive keys is stored, and integrity verification is performed before finalizing the signature. This technique yields 60% lower memory requirement (1800 KB vs 4500 KB compared to the baseline spatial redundancy method), while significantly increasing robustness against Rowhammer attacks by lowering the probability of a successful attack to 2⁻⁶⁴ and having a lower performance overhead for signature computation of 10%, compared to 30% overhead seen when using temporal redundancy.

The proposed method provides robustness for Dilithium signing algorithm against Rowhammer attacks with a reduced performance and memory overhead compared to other techniques. The proposed technique improves algorithms in the post-quantum crypto space by offering a robust digital signature scheme for applications such as Attestation, TLS etc.

In the following, a defense against potential Rowhammer attacks on Dilithium is shown. Compared to traditional fault attacks, Rowhammer attacks have some constraints. The limitations of Rowhammer on Dilithiums signature generation function were identified and used to develop an in-depth defense mechanism that explores spatial redundancies. In particular, the proposed concept is based on identifying potential targets of Rowhammer in Dilithium signing: the secret polynomials s₁, public matrix A, seed ρ to generate the public matrix, message digest μ, and round constants of SHA-3 (Secure Hash Algorithm 3). Multiple (N) copies of (all) potentially vulnerable Rowhammer variables are kept. At the end of the signing process, the copies (and originals) are compared to confirm that all copies are equal before releasing the signature. In a Rowhammer-based attack, an attacker cannot uncover the private key without a faulty signature. However, inducing the exact same bit-flips on N different locations during the same time is infeasible, such that attacks are thwarted by the spatial redundancy of the potential targets.

In general, verification after signing may introduce a 30% performance overhead. Re-executing the signing algorithm to compare the result may introduce 100% performance overhead. A naïve copy of the entire address space may incur a N*100% memory overhead. The present disclosure explores a more efficient methodology by taking advantage of the fact that for a Rowhammer attack to succeed, it has to trigger faults at specific but not arbitrary location in variables that exist in the dynamic random-access memory (have physical pages backing up).

Above, potential targets of Rowhammer were identified: s₁, A, μ, ρ, and buffers allocated by hash function H. If a Rowhammer attack is launched on the server, one or more bits have to be flipped in these buffers by the time the algorithm terminates. Therefore, an efficient defense can apply spatial redundancy to these buffers. In the defense, buffers in the Dilithium algorithm that are vulnerable to Rowhammer attack are identified. Some buffers may be long-term buffers (e.g., ρ), and some may be short term buffers (e.g., γ). The difference between long-term and short-term buffers is the allocation duration of the buffer. Short-term buffers might only be allocated within the algorithm. Long-term buffers may be allocated since the key generation and stay allocated across multiple Dilithium executions.

For a long-term buffer, N copies of it may be allocated by the time of key generation. After Dilithium terminates, the N copies may be compared to confirm that they are equal. As a result, if an attacker wants to bypass this defense, they need to trigger identical faults among N different copies. As N gets larger than 2, this task may be heuristically impossible to achieve. This defense can be further improved by profiling the DRAM (Dynamic Random-Access Memory). For example, the defender/system manager, may profile the whole DRAM and identify the rows/physical pages that are vulnerable to a Rowhammer attack. When the N copies of a long-term buffer are allocated, mapping them to vulnerable locations may be avoided. By doing so, most efforts (allocating N copies) are spent with key generation. When signing requests come in, the time spent in real time to compare buffers is minimal.

For short-term buffers, N copies may be allocated during Dilithium execution, and the N copies (and original) may be compared when the algorithm terminates. The performance overhead scales with N but should be smaller than 30 percent.

In the following, an overhead analysis is performed. Probability assumption: When analyzing the security of the proposed N copy defense, the probability to flip a bit is assumed to be at most 0.06% (see Kim et al: Flipping bits in memory without accessing them: An experimental study of DRAM disturbance errors). Supposing an attacker flips a bit in one of the target buffers that is vulnerable to Rowhammer, the probability to trigger the identical disturbance pattern in N other copies is bounded by 0.0006^{N}*(1−0.0006)^{N*8191}. This equation is based on the probability of a single bit to flip being bounded by 0.0006, and based on, when the attacker is hammering a victim row, they must hammer the entire row (normally 8192 bits) together rather than focusing on a single bit. To trigger a bit flip at a specific position and no bit flip at all other positions, the attacker may have a probability of 0.0006*(1−0.0006)⁸¹⁹¹. In the end, the result is 0.0006^{N}*(1−0.0006)^{N*8191} when scaled to N copies.

In an experimental setup, Dilithium security level 5 (Reference implementation of Dilithium NIST submission) was targeted. For performance overhead, the time to execute the Dilithium sign operation with the proposed defense mechanism that allocates N copies for spatial redundancy was measured. The time it takes to execute Dilithium sign plus verify operation as was measured as baseline performance overhead.

For memory overhead, the Dilithium signing peak RSS (resident set size) was measured, which reflects the maximum amount of allocated physical memory for the program. The RSS of our defense mechanism was reported with varying N. The baseline memory overhead is reported as N times the RSS of Dilithium signing with no defense (N=0);

For each experiment, 10,000 iterations were executed, and the number of copies N was varied. When measuring time, we use the x86 instruction RDTSC was used to determine the current processor cycle.

FIG. 2 shows a diagram of a performance overhead. In FIG. 2, the experimental result of the performance overhead is shown. In the x axis, the number of copies N is plotted. In the y axis on the left-hand side (dots 210), the processor cycles the CPU spends on executing Dilithium signing with the proposed defense (when varying N). In the y axis on the right-hand side (dots 220), the attacker's probability to successfully bypass the defense is shown (when varying N), under the assumption that every bit can be flipped with probability 0.06%. For the baseline defense of verify-and-sign, 1.4×10¹⁰ cycles were measured. Using the proposed defense mechanism, when N=5, overwhelmingly high security can be obtained, with the attacker having a negligible probability (2⁻⁶⁴) to bypass the defense, with 1.2×10¹⁰ CPU cycles which translate to a 10% performance overhead.

FIG. 3 shows a diagram of a memory overhead. In FIG. 3, the experimental result of the memory overhead is presented. On the x axis, the number of copies N is plotted. On the Y axis, the Resident Set Size (RSS) is shown. Dots 310 are plotted to show the Dilithium signing with the proposed defense (varying N) as the memory overhead of the proposed mechanism. Dots 320 are plotted to show N time the RSS of default Dilithium signing as baseline memory overhead. It is evident that the proposed mechanism achieves a much lower memory overhead. When N=5, the baseline protection incurs around 500% memory overhead while the proposed mechanism incurs only 100% memory overhead.

The proposed mechanism recognizes the importance of preparing for the post-quantum era and ensuring the security of digital communications and systems. As quantum computing continues to advance, there is a growing need to develop and implement PQC algorithms that can protect sensitive data and ensure the integrity of digital transactions.

Background information on the Crystals-Dilithium signature algorithm can be found, for example, in Shi Bai et al: CRYSTALS-Dilithium. Algorithm Specifications and Supporting Documentation (Version 3.1) (Feb. 8, 2021), which is used as the basis for the nomenclature of variables used in the present document.

The pseudocode shown in FIG. 4 of Shi Bai et al: CRYSTALS-Dilithium. Algorithm Specifications and Supporting Documentation (Version 3.1), defines deterministic and randomized versions of Dilithium. Line 12 in the Sign algorithm distinguishes the deterministic version from the randomized version. In deterministic Dilithium, ρ at Line 12 is generated pseudo-randomly depending on the input message. In randomized Dilithium, ρ at Line 12 is generated randomly.

Based on the pseudocode, the Dilithium public key and secret key are determined.
Public key: ρ, t₁
Secret key: ρ, K, tr, s₁, s₂, t₀. Leaking s₁ breaks Dilithium.

In the following, the threat model is discussed. Rowhammer is a fault attack without physical access. The attackers can inject faults, but their ability is significantly constrained, as attackers can only trigger faults on buffers that have physical pages backing up by flipping bits in the DRAM. For example, the value in a register cannot be faulted. Once a fault is triggered in the DRAM, it may take 64 ms (refresh interval) for the fault to be observable in the upper-level software system.

Islam et al: Signature Correction Attack on Dilithium Signature Scheme performed a Rowhammer attack on randomized Dilithium that retrieves partial bits of the secret key and reduced the security guarantee of Dilithium from 2¹²⁸ to 2⁸¹. In the paper, randomized Dilithium was targeted and the Rowhammer threat model was used. The paper assumes that the secret key s₁ is stored as a long-term buffer backing up by physical pages that are vulnerable to Rowhammer. The attack works by flipping a random bit in the secret key s₁. Supposing one bit is flipped in s₁, the flipped s₁ is denoted as s′₁. Line 19 in the Sign algorithm z=y+cs₁ is observed. If a random one-bit fault is triggered in s₁→s′₁, the signature would be z′=y+cs′₁. The faulty z′ does not verify, but it is possible to modify z′ with a signature correction algorithm such that an attacker learns one bit of s₁. The reason is that the difference Δs₁ between s₁ and s′₁ is unknown but can be guessed. The total possibility of Δs₁ equals to the total number of coefficients in s₁ times 2, corresponding to bit flips from 0→1 and 1→0. The attacker guesses each possible Δs₁, cancels cΔs₁ in z′, and finally verifies z′−cΔs₁. If z′−cΔs₁ verifies, then Δs₁ is a correct guess. The attacker learns the position i of the flipped bit from the position of Δs₁, and learns the original value of s₁ at i is 1 if Δs₁ is 1→0, 0 if Δs₁ is 0→1. The attack recovers a bit in s₁ by triggering a bit flip in the DRAM. To recover all bits, it needs to flip every single bit in s₁, which means that every bit in the physical page backing up s₁ must be flippable. This assumption is not realistic and limits the attack.

More details and aspects of the concept and methods to protect Crystals-Dilithium against Rowhammer attacks are mentioned in connection with the proposed concept or one or more examples described above or below (e.g., FIG. 1a to 1b). The concept and methods to protect Crystals-Dilithium against Rowhammer attacks may comprise one or more additional optional features corresponding to one or more aspects of the proposed concept, or one or more examples described above or below.

In the following, some examples of the proposed concept are presented:

An example (e.g., example 1) relates to an apparatus (10) for determining an integrity of a generated cryptographic signature, the apparatus comprising memory circuitry (16), machine-readable instructions, and processor circuitry (14) to execute the machine-readable instructions to generate, before generating the cryptographic signature, redundancy information of at least one cryptographic secret being used for generating the cryptographic signature, generate the cryptographic signature using the at least one cryptographic secret, compare, after generating the cryptographic signature, the redundancy information and the at least one cryptographic secret to determine whether the redundancy information matches the at least one cryptographic secret, and use the cryptographic signature if the redundancy information matches the at least one cryptographic secret.

Another example (e.g., example 2) relates to a previous example (e.g., example 1) or to any other example, further comprising that the processor circuitry is to execute the machine-readable instructions to determine a manipulation of the at least one cryptographic secret or of the redundancy information if the redundancy information fails to match the at least one cryptographic secret, and to discard the cryptographic signature if a manipulation is determined.

Another example (e.g., example 3) relates to a previous example (e.g., example 2) or to any other example, further comprising that the manipulation being determined is based on electrical interaction between adjacent memory cells of the memory circuitry due to repeated access of the memory cells.

Another example (e.g., example 4) relates to a previous example (e.g., one of the examples 1 to 3) or to any other example, further comprising that the cryptographic signature is generated according to a quantum-safe cryptographic signing algorithm.

Another example (e.g., example 5) relates to a previous example (e.g., one of the examples 1 to 4) or to any other example, further comprising that the cryptographic signature is generated according to the Crystal-Dilithium cryptographic signing algorithm.

Another example (e.g., example 6) relates to a previous example (e.g., example 5) or to any other example, further comprising that the at least one cryptographic secret comprises at least one of the cryptographic parameters s₁, A, μ, ρ of the Crystal-Dilithium cryptographic signing algorithm.

Another example (e.g., example 7) relates to a previous example (e.g., one of the examples 1 to 6) or to any other example, further comprising that the redundancy information comprises at least one redundant copy of at least a portion of the at least one cryptographic secret.

Another example (e.g., example 8) relates to a previous example (e.g., example 7) or to any other example, further comprising that the redundancy information comprises at least three redundant copies of at least the portion of the at least one cryptographic secret.

Another example (e.g., example 9) relates to a previous example (e.g., one of the examples 7 or 8) or to any other example, further comprising that the processor circuitry is to execute the machine-readable instructions to determine a number of redundant copies by testing the memory circuitry being used to store the at least one cryptographic secret.

Another example (e.g., example 10) relates to a previous example (e.g., example 9) or to any other example, further comprising that the processor circuitry is to execute the machine-readable instructions to test the memory circuitry by repeatedly accessing memory cells being located in proximity to a target cell to determine an effort required for flipping at least one bit stored in the target cell.

Another example (e.g., example 11) relates to a previous example (e.g., one of the examples 7 to 10) or to any other example, further comprising that the at least one cryptographic secret comprises at least one short-term cryptographic parameter and at least one long-term cryptographic parameter, wherein the processor circuitry is to execute the machine-readable instructions to generate a larger number of redundant copies for the at least one long-term cryptographic parameter than for the at least one short-term cryptographic parameter.

Another example (e.g., example 12) relates to a previous example (e.g., example 11) or to any other example, further comprising that the processor circuitry is to execute the machine-readable instructions to forego generating a redundant copy for the at least one short-term cryptographic parameter.

Another example (e.g., example 13) relates to a previous example (e.g., one of the examples 1 to 6) or to any other example, further comprising that the redundancy information comprises a hash of the at least one cryptographic secret.

Another example (e.g., example 14) relates to a previous example (e.g., example 13) or to any other example, further comprising that the processor circuitry is to execute the machine-readable instructions to generate the hash using a cryptographic hashing function.

Another example (e.g., example 15) relates to a previous example (e.g., one of the examples 13 or 14) or to any other example, further comprising that the processor circuitry is to execute the machine-readable instructions to re-generate the hash based on the at least one cryptographic secret after generating the cryptographic signature, and to compare the hash and the re-generated hash.

Another example (e.g., example 16) relates to a previous example (e.g., one of the examples 1 to 15) or to any other example, further comprising that the at least one cryptographic secret comprises at least one short-term cryptographic parameter and at least one long-term cryptographic parameter, wherein the processor circuitry is to execute the machine-readable instructions to forego generating redundancy information for the at least one short-term cryptographic parameter.

An example (e.g., example 17) relates to an apparatus (10) for determining an integrity of a generated cryptographic signature, the apparatus comprising processor circuitry (14) configured to generate, before generating the cryptographic signature, redundancy information of at least one cryptographic secret being used for generating the cryptographic signature, generate the cryptographic signature using the at least one cryptographic secret, compare, after generating the cryptographic signature, the redundancy information and the at least one cryptographic secret to determine whether the redundancy information matches the at least one cryptographic secret, and use the cryptographic signature if the redundancy information matches the at least one cryptographic secret.

An example (e.g., example 18) relates to a device (10) for determining an integrity of a generated cryptographic signature, the device comprising means for processing (14) for generating, before generating the cryptographic signature, redundancy information of at least one cryptographic secret being used for generating the cryptographic signature, generating the cryptographic signature using the at least one cryptographic secret, comparing, after generating the cryptographic signature, the redundancy information and the at least one cryptographic secret to determine whether the redundancy information matches the at least one cryptographic secret, and using the cryptographic signature if the redundancy information matches the at least one cryptographic secret.

Another example (e.g., example 19) relates to a computer system (100) or mobile device (100) comprising the apparatus (10) or device (10) according to one of the examples 1 to 18 (or according to any other example).

An example (e.g., example 20) relates to a method for determining an integrity of a generated cryptographic signature, the method comprising generating (110), before generating the cryptographic signature, redundancy information of at least one cryptographic secret being used for generating the cryptographic signature, generating (120) the cryptographic signature using the at least one cryptographic secret, comparing (130), after generating the cryptographic signature, the redundancy information and the at least one cryptographic secret to determine whether the redundancy information matches the at least one cryptographic secret, and using (150) the cryptographic signature if the redundancy information matches the at least one cryptographic secret.

Another example (e.g., example 21) relates to a previous example (e.g., example 20) or to any other example, further comprising that the method comprises determining (140) a manipulation of the at least one cryptographic secret or of the redundancy information if the redundancy information fails to match the at least one cryptographic secret and discarding (155) the cryptographic signature if a manipulation is determined.

Another example (e.g., example 22) relates to a previous example (e.g., example 21) or to any other example, further comprising that the manipulation being determined is based on electrical interaction between adjacent memory cells of memory circuitry due to repeated access of the memory cells.

Another example (e.g., example 23) relates to a previous example (e.g., one of the examples 20 to 22) or to any other example, further comprising that the cryptographic signature is generated according to a quantum-safe cryptographic signing algorithm.

Another example (e.g., example 24) relates to a previous example (e.g., one of the examples to 23) or to any other example, further comprising that the cryptographic signature is generated according to the Crystal-Dilithium cryptographic signing algorithm.

Another example (e.g., example 25) relates to a previous example (e.g., example 24) or to any other example, further comprising that the at least one cryptographic secret comprises at least one of the cryptographic parameters s₁, A, μ, ρ of the Crystal-Dilithium cryptographic signing algorithm.

Another example (e.g., example 26) relates to a previous example (e.g., one of the examples to 25) or to any other example, further comprising that the redundancy information comprises at least one redundant copy of at least a portion of the at least one cryptographic secret.

Another example (e.g., example 27) relates to a previous example (e.g., example 26) or to any other example, further comprising that the redundancy information comprises at least three redundant copies of at least the portion of the at least one cryptographic secret.

Another example (e.g., example 28) relates to a previous example (e.g., one of the examples 26 or 27) or to any other example, further comprising that the method comprises determining (112) a number of redundant copies by testing (114) memory circuitry being used to store the at least one cryptographic secret.

Another example (e.g., example 29) relates to a previous example (e.g., example 28) or to any other example, further comprising that the method comprises testing (114) the memory circuitry by repeatedly accessing memory cells being located in proximity to a target cell to determine an effort required for flipping at least one bit stored in the target cell.

Another example (e.g., example 30) relates to a previous example (e.g., one of the examples 26 to 29) or to any other example, further comprising that the at least one cryptographic secret comprises at least one short-term cryptographic parameter and at least one long-term cryptographic parameter, wherein the method comprises generating (116) a larger number of redundant copies for the at least one long-term cryptographic parameter than for the at least one short-term cryptographic parameter.

Another example (e.g., example 31) relates to a previous example (e.g., example 30) or to any other example, further comprising that generating (116) a redundant copy is foregone for the at least one short-term cryptographic parameter.

Another example (e.g., example 32) relates to a previous example (e.g., one of the examples to 25) or to any other example, further comprising that the redundancy information comprises a hash of the at least one cryptographic secret.

Another example (e.g., example 33) relates to a previous example (e.g., example 32) or to any other example, further comprising that the method comprises generating (118a) the hash using a cryptographic hashing function.

Another example (e.g., example 34) relates to a previous example (e.g., one of the examples 32 or 33) or to any other example, further comprising that the method comprises re-generating (118b) the hash based on the at least one cryptographic secret after generating the cryptographic signature, and to compare the hash and the re-generated hash.

Another example (e.g., example 35) relates to a previous example (e.g., one of the examples to 34) or to any other example, further comprising that the at least one cryptographic secret comprises at least one short-term cryptographic parameter and at least one long-term cryptographic parameter, wherein generating redundancy information is foregone for the at least one short-term cryptographic parameter.

Another example (e.g., example 36) relates to a computer system (100) or mobile device (100) to perform the method according to one of the examples 20 to 35 (or according to any other example).

Another example (e.g., example 37) relates to a non-transitory, computer-readable medium comprising a program code that, when the program code is executed on a processor, a computer, or a programmable hardware component, causes the processor, computer, or programmable hardware component to perform the method of one of the examples 20 to 35 (or according to any other example).

Another example (e.g., example 38) relates to a non-transitory machine-readable storage medium including program code, when executed, to cause a machine to perform the method of one of the examples 20 to 35 (or according to any other example).

Another example (e.g., example 39) relates to a computer program having a program code for performing the method of one of the examples 20 to 35 when the computer program is executed on a computer, a processor, or a programmable hardware component.

Another example (e.g., example 40) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for determining an integrity of a generated cryptographic signature, the apparatus comprising memory circuitry, machine-readable instructions, and processor circuitry to execute the machine-readable instructions to:
generate, before generating the cryptographic signature, redundancy information of at least one cryptographic secret being used for generating the cryptographic signature;
generate the cryptographic signature using the at least one cryptographic secret;
compare, after generating the cryptographic signature, the redundancy information and the at least one cryptographic secret to determine whether the redundancy information matches the at least one cryptographic secret; and
use the cryptographic signature if the redundancy information matches the at least one cryptographic secret.

2. The apparatus according to claim 1, wherein the processor circuitry is to execute the machine-readable instructions to determine a manipulation of the at least one cryptographic secret or of the redundancy information if the redundancy information fails to match the at least one cryptographic secret, and to discard the cryptographic signature if a manipulation is determined.

3. The apparatus according to claim 2, wherein the manipulation being determined is based on electrical interaction between adjacent memory cells of the memory circuitry due to repeated access of the memory cells.

4. The apparatus according to claim 1, wherein the cryptographic signature is generated according to a quantum-safe cryptographic signing algorithm.

5. The apparatus according to claim 1, wherein the cryptographic signature is generated according to the Crystal-Dilithium cryptographic signing algorithm.

6. The apparatus according to claim 5, wherein the at least one cryptographic secret comprises at least one of the cryptographic parameters s₁, A, μ, ρ of the Crystal-Dilithium cryptographic signing algorithm.

7. The apparatus according to claim 1, wherein the redundancy information comprises at least one redundant copy of at least a portion of the at least one cryptographic secret.

8. The apparatus according to claim 7, wherein the redundancy information comprises at least three redundant copies of at least the portion of the at least one cryptographic secret.

9. The apparatus according to claim 7, wherein the processor circuitry is to execute the machine-readable instructions to determine a number of redundant copies by testing the memory circuitry being used to store the at least one cryptographic secret.

10. The apparatus according to claim 9, wherein the processor circuitry is to execute the machine-readable instructions to test the memory circuitry by repeatedly accessing memory cells being located in proximity to a target cell to determine an effort required for flipping at least one bit stored in the target cell.

11. The apparatus according to claim 7, wherein the at least one cryptographic secret comprises at least one short-term cryptographic parameter and at least one long-term cryptographic parameter, wherein the processor circuitry is to execute the machine-readable instructions to generate a larger number of redundant copies for the at least one long-term cryptographic parameter than for the at least one short-term cryptographic parameter.

12. The apparatus according to claim 11, wherein the processor circuitry is to execute the machine-readable instructions to forego generating a redundant copy for the at least one short-term cryptographic parameter.

13. The apparatus according to claim 1, wherein the redundancy information comprises a hash of the at least one cryptographic secret.

14. The apparatus according to claim 13, wherein the processor circuitry is to execute the machine-readable instructions to generate the hash using a cryptographic hashing function.

15. The apparatus according to claim 13, wherein the processor circuitry is to execute the machine-readable instructions to re-generate the hash based on the at least one cryptographic secret after generating the cryptographic signature, and to compare the hash and the re-generated hash.

16. The apparatus according to claim 1, wherein the at least one cryptographic secret comprises at least one short-term cryptographic parameter and at least one long-term cryptographic parameter, wherein the processor circuitry is to execute the machine-readable instructions to forego generating redundancy information for the at least one short-term cryptographic parameter.

17. A method for determining an integrity of a generated cryptographic signature, the method comprising:
generating, before generating the cryptographic signature, redundancy information of at least one cryptographic secret being used for generating the cryptographic signature;
generating the cryptographic signature using the at least one cryptographic secret;
comparing, after generating the cryptographic signature, the redundancy information and the at least one cryptographic secret to determine whether the redundancy information matches the at least one cryptographic secret; and
using the cryptographic signature if the redundancy information matches the at least one cryptographic secret.

18. The method according to claim 17, wherein the method comprises determining a manipulation of the at least one cryptographic secret or of the redundancy information if the redundancy information fails to match the at least one cryptographic secret and discarding the cryptographic signature if a manipulation is determined.

19. The method according to claim 18, wherein the manipulation being determined is based on electrical interaction between adjacent memory cells of memory circuitry due to repeated access of the memory cells.

20. A non-transitory, computer-readable medium comprising a program code that, when the program code is executed on a processor, a computer, or a programmable hardware component, causes the processor, computer, or programmable hardware component to perform the method of claim 17.
